(19) United States
(12) Patent Application Publication
(10) Pub. No.: US 2003/0112805 A1
(43) Pub. Date: Jun. 19, 2003

(54) Method and apparatus for providing device-to-device connectivity using shared infiniband NIC device

(76) Inventor: Kevin B. Stanton, Hillsboro, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/021,056

(22) Filed: Dec. 19, 2001

(51) Int. Cl. H04L 12/56

(52) U.S. Cl. 370/395.1; 370/463

(57) ABSTRACT

A shared NIC device that includes an input interface and output interface connected to an InfiniBand Architecture (IBA) subnet, a network input interface, a network output interface, and a controller. The IBA subnet has two or more devices attached. The network input interface processes information received from a network. The network output interface processes information to be sent to the network. When a packet is received at the input interface from one of the two devices where a destination address of the packet is that of a second of the devices, the controller sends the packet across the output interface to the second device without sending the packet to the network. The network may be any type network such as a Fibre Channel network, SCSI network, ATM network, SONET, or Ethernet. The two or more devices may be InfiniBand host devices and/or InfiniBand target devices.

### BACKGROUND

1. Field of the Invention

This invention relates to InfiniBand Architecture subnets, and more specifically to information transfer between devices on the same InfiniBand subnet using a shared Network Interface Card (NIC) device. The devices may be host devices and/or target devices.

2. Background Information

The InfiniBand architecture defines a system area network (SAN) for connecting multiple independent processor platforms (i.e., host processor nodes), I/O platforms, and I/O devices in a cluster across a switched communications fabric that allows many devices to concurrently communicate, and allows for higher performance and better reliability, accessibility and serviceability (RAS) characteristics. A cluster consists of one or more subnets interconnected by routers.

FIG. 1 shows an example InfiniBand cluster of a single subnet. A subnet is a collection of systems, I/O enclosures, and switches. This subnet consists of four hosts, 10, 12, 14 and 16. These hosts are interconnected via switches 20, 22 and 24. The hosts may also be connected to I/O devices 26 and 28 via switches 20, 22 and 24. Hosts and I/O devices are connected to the switches via one or more channel adapters 18.

To allow communication from host devices in an InfiniBand subnet to devices in another network, a bridging device, such as a network interface card (NIC), may be used. For example, if a host device on an InfiniBand subnet desires to transmit information from the subnet across the Internet, a bridging device which bridges the InfiniBand subnet to an Ethernet network may be used. InfiniBand devices can communicate with each other on the same subnet through the switches, or over an Internet Protocol (IP) network through a bridging device. These bridging devices connect the InfiniBand subnet to an Ethernet switch. The traffic from one InfiniBand subnet host travels from the InfiniBand subnet through the bridging device to the Ethernet switch and is then routed to the desired destination node. The destination node may be a node on the Internet, or may be another InfiniBand node that resides on a different subnet.

However, a problem exists when the destination node of a packet is part of the same InfiniBand subnet as the source node. Many network switches, such as Ethernet switches, do not send packets received from one source or on one port (e.g., InfiniBand subnet) back to the same port/network that the packets were received from. The network switch assumes that every device on the received side has already seen the packet since the packet came from there. Therefore, if packets are received with a destination address designating a device on the same InfiniBand subnet as the source, the packets may be discarded by the network switch. Since a host device that is sending the packets and a host device that is receiving the packets may both reside on the same InfiniBand subnet and both may be connected to another network (e.g., IP network), there is no guarantee which path packets sent from the source host device to the destination host device may take. For example, packets sent from a source host device may travel through Infiniband switches on an InfiniBand subnet to the destination host device, or may be routed through a bridging device to a network with the desire that the packets be then sent back to the same Infiniband subnet to the destination host device. Since packets sent to a switch on the network may be dropped, due to the reason mentioned above, host devices on the same subnet cannot communicate to each other over the network.

One method of solving this problem is to allow only one host to talk to the NIC device. However, in this solution one NIC device would then be needed for each individual host device, therefore, requiring multiple NIC devices per subnet. Another possible solution is to restrict or guarantee that each host device on the same InfiniBand subnet does not send packets to each other over the network. However, in a real network and system this cannot be controlled. In still another possible solution, the network switch may be programmed to detect this situation and reflect packets from the same subnet back to that subnet if the destination address is one of a host device on that subnet. However, this requires the network switch to operate in a nonstandard way. In a further way of solving this problem, a separate driver may be loaded to implement and intra-InfiniBand local area network (LAN) network emulation. However, then one needs to guarantee that the binding order/precedence from host name to network address would insure that traffic between the two host devices always took the intra-InfiniBand LAN emulation route and not the remote shared NIC device route.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of an example InfiniBand cluster of a single subnet;

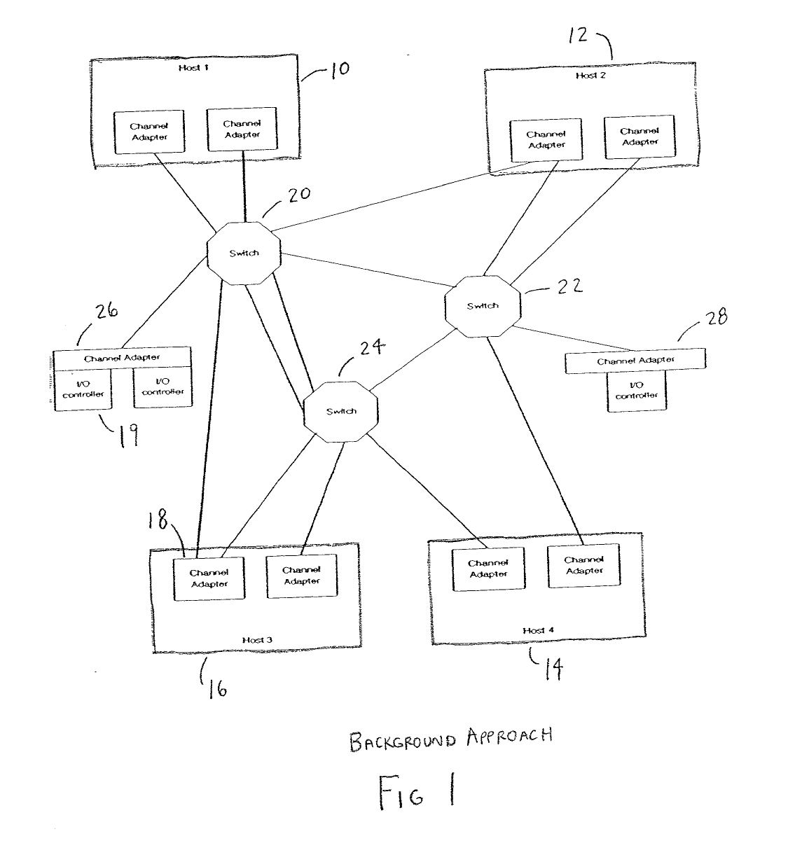

FIG. 2 is a block diagram of a network architecture using a shared NIC device according to an example embodiment of the present invention;

FIG. 3 is a block diagram of an InfiniBand subnet with a shared NIC device according to an example embodiment of the present invention;

FIG. 4 is a block diagram of a shared NIC device interfacing to an Ethernet according to an example embodiment of the present invention; and

FIG. 5 is a flowchart of a process for a shared NIC device according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to method and apparatus for providing device-to-device connectivity using a shared InfiniBand Network Interface Card (NIC) device where the NIC device provides network connectivity to multiple InfiniBand devices that are all connected to the same InfiniBand fabric through a mesh of InfiniBand switches. This allows direct memory access and channel-based input/output (I/O) between nodes on the fabric. The devices may be InfiniBand host devices and/or InfiniBand target device. Host devices will be used to help illustrate the present invention.

According to the present invention, when a packet arrives at a NIC device from the network side/port, the NIC device decides which host device to send the packet to on the InfiniBand side, and does so. When a packet arrives at the NIC device from the InfiniBand side/port, the packet is typically forwarded on to the network side. However, a NIC device according to the present invention detects a condition where the destination of the packet is to a host device on the same InfiniBand subnet, and then implements a reflection mechanism whereby the packet is forwarded back into the InfiniBand fabric destined to the appropriate InfiniBand host device. A shared NIC device according to the present invention examines the destination address of the packet received from the InfiniBand subnet. If the destination address belongs to one of the InfiniBand host devices on the same InfiniBand subnet, the shared NIC device does not transfer the packet across the network, but instead sends the packet back across the InfiniBand subnet to the destination host device. The destination InfiniBand host device is one of the InfiniBand hosts currently assigned to communicate to the network through the shared NIC device.

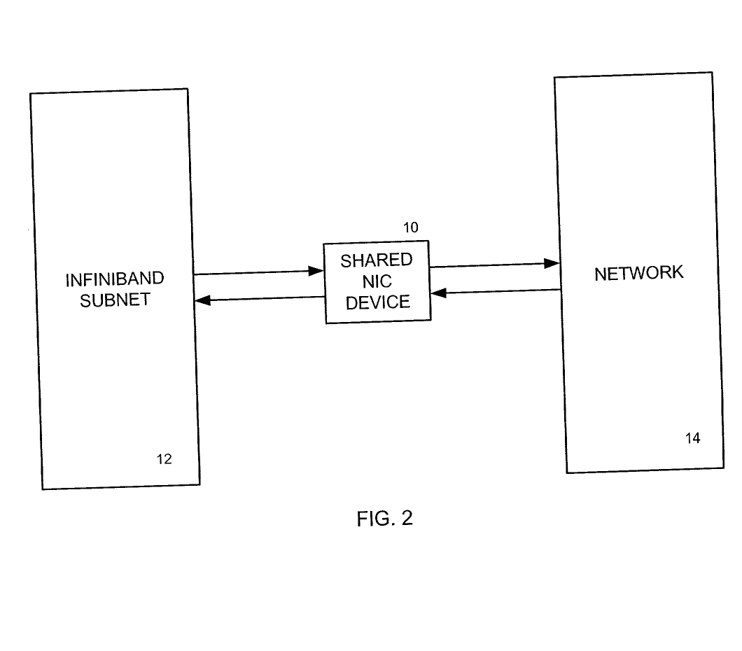

FIG. 2 shows a block diagram of a network architecture using a shared NIC device according to an example embodiment of the present invention. According to the present invention, a NIC device 10 provides a vehicle for passing packets between InfiniBand subnet 12 and a network 14. Although not shown, NIC device 10 includes an interface to InfiniBand subnet 12 for both receiving information and transmitting information. Similarly, NIC device 10 includes an interface to network 14 for transmitting information and receiving information. NIC device 10 formats the data received appropriately for transmission across the destination subnet or network. A NIC device 10 according to the present invention determines if packets received from InfiniBand subnet 12 have a destination address of a device on InfiniBand subnet 12 and if so, sends the packets received back to InfiniBand subnet 12 and does not send the packets to network 14.

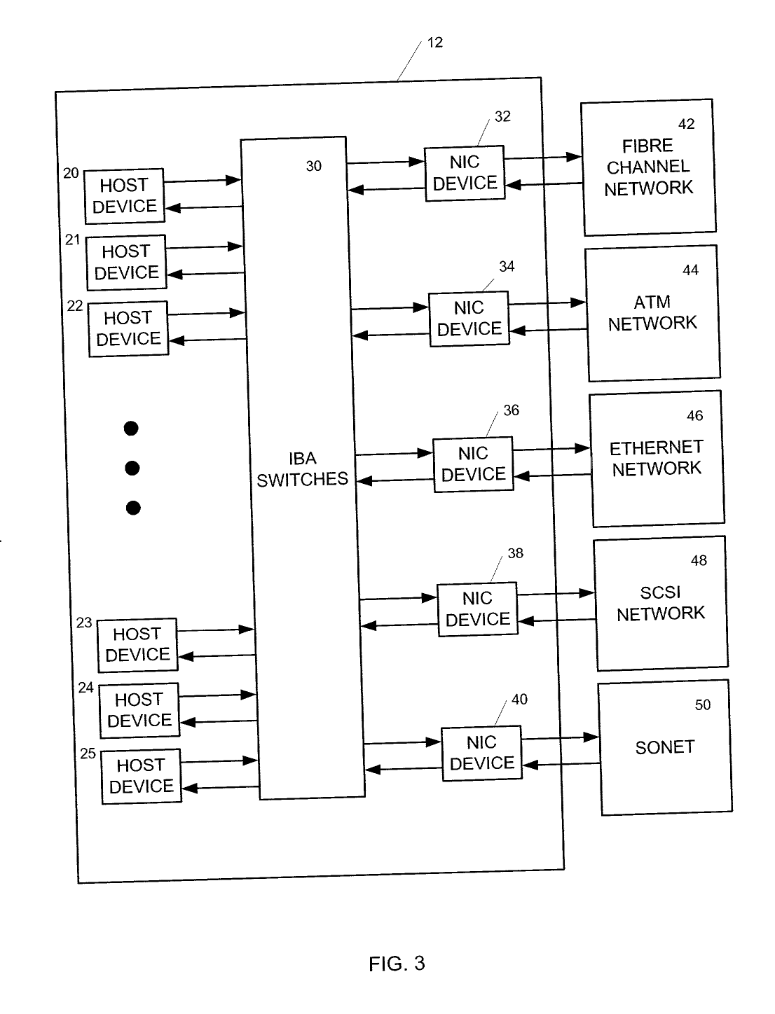

FIG. 3 shows a block diagram of an InfiniBand subnet with a shared NIC according to an example embodiment of the present invention. InfiniBand subnet 12 may include a plurality of host devices 20-25 interconnected via series of InfiniBand switches 30. Shared NIC devices 32, 34, 36, 38 and 40 may provide connectivity for assigned host devices to other networks such as a fiber channel network 42, Asynchronous Transfer Mode (ATM) network 44, Ethernet network 46, Small Computer System Interface (SCSI) network 48, a Synchronous Optical Network (SONET) 50, etc. Each host device has its own address (i.e., Media Access Control (MAC) address).

During initialization of InfiniBand subnet 12, one or more NIC devices may be assigned to one or more host devices. For example, host devices 20, 22, and 25 may be assigned NIC device 36 for transmission of packets across an Ethernet network 46. NIC device 36 stores addresses of host devices assigned to it. Therefore, one NIC device may be shared among multiple host devices on a subnet. Upon receiving a packet from a host device on InfiniBand network 30, shared NIC device 36 may first check to see if the packet is from a host device that has been assigned to NIC device 36. If the packet received is not from an assigned host device, NIC device 36 may drop the packet. In contrast, if the packet received from the InfiniBand subnet is from a host device assigned to shared NIC device 36, NIC device 36 formats the received packet into an appropriate Ethernet packet and transfers this to Ethernet network 46. Similarly, other shared NIC devices (e.g., 42, 44, 48, 50) may be assigned certain host devices and store the addresses of their assigned host devices.

Although FIG. 3 shows several different NIC devices 32-40 connected to different networks 42-50, only one NIC device may be attached to a particular InfiniBand subnet 12, or a few NIC devices attached to an InfiniBand network 12 and still be within the spirit and scope of the present invention. Further, there may be two or more NIC devices that interface to the same network as well as being attached to the InfiniBand subnet 12. For example, two NIC devices may be connected between an InfiniBand subnet and the same ATM network. Further, although only six host devices are shown, InfiniBand subnet 12 may include a large number of host devices as well as other network devices (e.g., input/output controllers, etc.). Moreover, although not shown, each network 42-50 may include a switching or routing device that receives and transmits packets between the network and the InfiniBand subnet 12 through the associated NIC device.

According to the present invention, if a NIC device receives a packet from a host device, for example, host device 20, that has a destination address of another host device on the same InfiniBand subnet 12, for example host 24, the NIC device detects this and does not transfer the packet across the associated network 42-50, but instead sends the packet back to InfiniBand subnet 12 to destination host device 24 just as though it were received from the network 42-50.

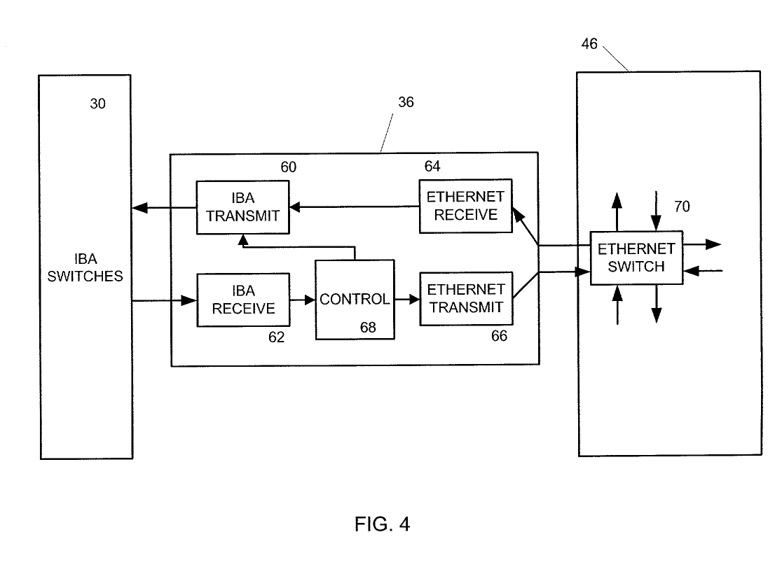

FIG. 4 shows a block diagram of a shared NIC device interfacing to an Ethernet according to an example embodiment of the present invention. Shared NIC device 36 interfaces between the cluster of InfiniBand Architecture (IBA) switches 30 (with attached host devices) and an Ethernet network 46. Shared NIC device 36 may include an IBA transmit interface 60, an IBA receive interface 62, an Ethernet receive interface 64, an Ethernet transmit interface 66, and control logic 68. Control logic 68 may include one or more storage devices for storing addresses from assigned host devices on InfiniBand subnet 12. Further, a comparator and/or software may reside in control logic 68 that compares destination addresses in packets received from the InfiniBand subnet with stored addresses.

InfiniBand receive interface 62 receives the packets; reassembles them, and reformats them into Ethernet packets. Similarly, Ethernet receive interface 64 receives Ethernet frames from Ethernet 46, reassembles the frames, and formats them for transfer to the InfiniBand subnet. IBA transmit interface 60 and Ethernet transmit interface 66 both may perform packet segmentation. Ethernet transmit interface 66 may reformat packets received into Ethernet packet sizes for sending across Ethernet network 46. Similarly, IBA architecture transmit interface 60 may perform segmentation on received packets from network 46 or control logic 68 to transfer the packets across InfiniBand subnet 12.

Control logic 68 examines the destination address in a packet received from InfiniBand architecture receive interface 62 and compares this with Media Access Control (MAC) addresses stored of host devices on subnet 12. If there is an address match, control logic 68 routes the packet to IBA transmit interface 60 for sending across InfiniBand subnet 12 to the destination host device. The packet is not sent to Ethernet transmit interface 66 and, therefore, is not sent to Ethernet network 46. In contrast, if the destination address in the packet does not match a stored MAC address, control logic 68 sends the packet to Ethernet transmit interface 66 for sending across Ethernet network 46. Ethernet network 46 may be an Internet Protocol (IP) network.

Ethernet switch 70 interfaces with shared NIC device 36 and receives packets and transmits packets from/to NIC device 36. According to the present invention, Ethernet switch 70 is not required to know that a destination address of a packet received from an InfiniBand subnet is to a host device on that same subnet. IBA transmit interface 60 receives packets from control logic 68 just as though they came directly from Ethernet receive interface 64 and Ethernet network 46. Therefore, in a shared NIC device according to the present invention, IBA transmit interface 60 does not distinguish between whether the Ethernet data came from Ethernet receive interface 64 (Ethernet switch 70) or internally from control logic 68.

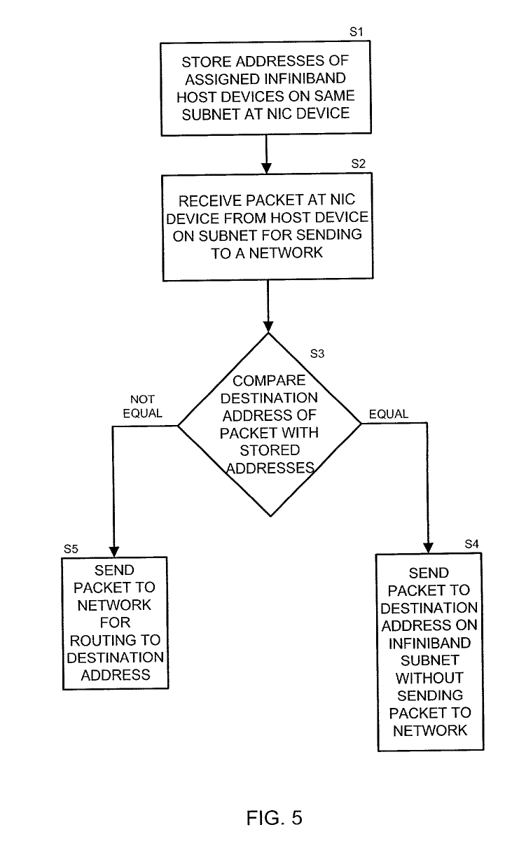

FIG. 5 is a flowchart of a process for a shared NIC device according to an example embodiment of the present invention. Addresses of host devices on the same InfiniBand subnet are stored at the shared NIC device S1. This may occur during initialization of the subnet. A packet is received at the shared NIC device from a host device on the InfiniBand subnet for sending to a network S2. A destination address in the received packet is compared with the stored addresses S3. The addresses may be MAC addresses, or other type addresses and still be within the spirit and scope of the present invention. If there is a comparison, the packet is sent to a host device at the destination address on the subnet without sending the packet to the network S4. If there is no address match, then the packet is sent to the network for routing to the destination address S5.

Methods and apparatus for host to host connectivity using a shared InfiniBand NIC device according to the present invention is advantageous in that communication is allowed between all InfiniBand hosts which communicate to network hosts regardless of whether or not the intra-InfiniBand LAN network is emulated and regardless of the order and priority of binding. The present invention may be used by any InfiniBand to X network (e.g., Ethernet, ATM, Fiber Channel, SCSI, SONET, etc.) network interface card where forwarding and switches disallow a packet to be forwarded to the same port it was received on. A shared NIC device according to the present invention is remote relative to any host and may be shared by many independent InfiniBand hosts. Moreover, although the present invention has been illustrated using Infiniband host devices, the present invention may also be used with Infiniband target channel adapters, or any other network device that may be attachable to a NIC device.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A shared NIC device comprising:
an input interface connected to an InfiniBand Architecture (IBA) subnet, the IBA subnet having at least two devices attached;
an output interface connected to the IBA subnet;
a network input interface, the network input interface processing information received from a network;
a network output interface, the network output interface processing information to be sent to the network; and
a controller,
wherein when a packet is received at the input interface from a first of the at least two devices where a destination address of the packet is a second of the at least two devices, the controller sends the packet across the output interface to the second at least two devices without sending the packet to the network.

2. The device according to claim 1, further comprising a controller that includes a storage device containing device addresses of at least some of the at least two devices and a comparator, the comparator comparing the destination address received with the device addresses.

3. The device according to claim 2, wherein the device addresses comprise Media Access Control (MAC) addresses.

4. The device according to claim 1, wherein the network comprises a Fibre Channel network.

5. The device according to claim 1, wherein the network comprises a Small Computer System Interface (SCSI) network.

6. The device according to claim 1, wherein the network comprises an Asynchronous Transfer Mode (ATM) network.

7. The device according to claim 1, wherein the network comprises a Synchronous Optical Network (SONET).

8. The device according to claim 1, wherein the network comprises an Ethernet network.

9. The device according to claim 1, wherein the at least two devices are attached to the IBA subnet through at least one router.

10. The method according to claim 1, wherein the at least two devices comprise at least one of InfiniBand host devices and InfiniBand target devices.

11. A method for providing device-to-device connectivity using a shared InfiniBand Architecture (IBA) Network Interface Card (NIC) device comprising:
storing addresses at a shared NIC of at least two devices connected to the same IBA subnet, the shared NIC being connected to the IBA subnet and to a network;
receiving a packet at the shared NIC from a first at least two devices for transmission across the network;
comparing a destination address of the packet with the stored addresses; and
sending the packet to a second at least two devices on the IBA subnet if the destination address matches one of the stored addresses without sending the packet across the network.

12. The method according to claim 11, further comprising storing the device addresses at the shared NIC during an initialization of the IBA subnet.

13. The method according to claim 11, further comprising storing Media Access Control (MAC) addresses at the shared NIC of the at least two devices connected to the same IBA subnet and comparing a MAC destination address of the packet with the stored MAC addresses.

14. The method according to claim 11, wherein the network is an Asynchronous Transfer Mode (ATM) network, further comprising sending the packet to a second at least two devices on the IBA subnet if the destination address matches one of the stored addresses without sending the packet across the ATM network.

15. The method according to claim 11, wherein the network is a Synchronous Optical Network (SONET), further comprising sending the packet to a second at least two devices on the IBA subnet if the destination address matches one of the stored addresses without sending the packet across the SONET.

16. The method according to claim 11, wherein the network is a Fibre Channel network, further comprising sending the packet to a second at least two devices on the IBA subnet if the destination address matches one of the stored addresses without sending the packet across the Fibre Channel network.

17. The method according to claim 11, wherein the network is a Small Computer System Interface (SCSI) network, further comprising sending the packet to a second at least two devices on the IBA subnet if the destination address matches one of the stored addresses without sending the packet across the SCSI network.

18. The method according to claim 11, wherein the network is an Ethernet network, further comprising sending the packet to a second at least two devices on the IBA subnet if the destination address matches one of the stored addresses without sending the packet across the Ethernet network.

19. The method according to claim 11, wherein the at least two devices comprise at least one of InfiniBand host devices and InfiniBand target devices.

20. A system for connectivity of InfiniBand nodes using a shared Network Interface Card (NIC) device comprising:
at least two devices connected to the same InfiniBand subnet;
at least one shared NIC device, the at least one shared NIC device operatively connected between the subnet and at least one network; and
at least one switch operatively connected to the subnet, the at least one switch providing connectivity between the at least two devices and at least one shared NIC device on the subnet,
wherein when a packet is received by the at least one shared NIC device from a first at least two devices where a destination address of the packet is for a second at least two devices, the at least one shared NIC device sends the packet to the second at least two devices without sending the packet to the at least one network.

21. The system according to claim 20, further comprising the at least one shared NIC device operatively connected between the subnet and a Fibre Channel network.

22. The system according to claim 20, further comprising the at least one shared NIC device operatively connected between the subnet and a Small Computer System Interface (SCSI) network.

23. The system according to claim 20, further comprising the at least one shared NIC device operatively connected between the subnet and a Asynchronous Transfer Mode (ATM) network.

24. The system according to claim 20, further comprising the at least one shared NIC device operatively connected between the subnet and a Synchronous Optical Network (SONET).

25. The system according to claim 20, further comprising the at least one shared NIC device operatively connected between the subnet and an Ethernet network.

26. The system according to claim 25, further comprising at least one Ethernet switch, the at least one shared NIC device operatively connected to the Ethernet network through the at least one Ethernet switch.

27. The system according to claim 20, the at least two devices connected to the same InfiniBand subnet through at least one router.

28. The system according to claim 20, wherein the at least two devices comprise at least one of InfiniBand host devices and InfiniBand target devices.
